(19) United States
(12) Patent Application Publication
(10) Pub. No.: US 2002/0081080 A1
(43) Pub. Date: Jun. 27, 2002

(54) Connector assembly

(76) Inventors: Olav Balle-Petersen, Humlebaek (DK); Morten Bruun-Larsen, Rodovre (DK)

Correspondence Address: BIRCH STEWART KOLASCH & BIRCH, PO BOX 747, FALLS CHURCH, VA, 22040-0747, US

(21) Appl. No.: 10/006,615

(22) Filed: Dec. 10, 2001

Related U.S. Application Data
(60) Provisional application No. 60/257,106, filed on Dec. 22, 2000.

(51) Int. Cl. G02B 6/42

(52) U.S. Cl. 385/93; 385/92

(57) ABSTRACT

A connector assembly for releasable connecting an optical fiber to a laser apparatus to allow a laser beam to be coupled into the fiber. Comprises a first connector part being positioned at the fiber and a second connector part being positioned at the laser apparatus. When the first and second connector parts are not connected, the first connector part protects the tip of the fiber. The first connector part further comprises a window positioned in the beam path of the laser beam emitted from the laser apparatus for further protection of the fiber tip. Dust and dirt is prevented from access to the fiber. The connector assembly may comprise information means for containing information about the fiber and/or a light emitting device, and information may be transferred from a handpiece to the information means via electrical, optical, mechanical and/or magnetical means.

### TECHNICAL FIELD

The invention relates to a connector assembly for releasable connecting an optical fiber to a laser apparatus. A first part of the connector assembly being fastened to the optical fiber whereby protecting a vulnerable tip of the optical fiber.

### BACKGROUND OF THE INVENTION

Expanded beam connectors are connectors typically connecting two optical fibers. Each connector at each optical fiber comprises a collimating lens so that a collimated beam is coupled from one fiber to the other. The demands for precise positioning of the two optical fibers are hereby reduced compared to the coupling of light directly between the tiny light-conductive cores of the two fibers.

When connecting two optical fibers they are, typically, not to be detached from each other at a regular basis. However, when connecting a fiber to a laser apparatus, the fiber may be regularly detached from the apparatus, and, furthermore, when the fiber is not connected to the apparatus, it is of high importance to protect the tip of the fiber. The reason being that at the tip of the fiber, a high power laser beam is focused so that the energy density at the tip of the fiber is high so that even small amounts of dust may be burned off and thus damage the fiber tip. Furthermore, small scratches on the fiber tip may scatter the high power light beam so that the coupling loss is increased significantly.

Furthermore, it is of importance that the connector positioned at the fiber has a weight and a size suitable for being permanently positioned on the fiber without inducing any breakage in the fiber.

### SUMMARY OF THE INVENTION

It is an object of the present invention to provide a connector assembly for connecting an optical fiber to a laser apparatus.

It is a further object of the present invention to provide a connector assembly wherein at least a part of the connector assembly protects the tip of the optical fiber when the fiber is not connected to the laser apparatus.

It is a further object of the present invention to provide a connector assembly ensuring that a laser beam will not be emitted from the laser apparatus when the optical fiber is not connected or not correctly connected to the laser apparatus.

It is a still further object of the present invention to provide a connector assembly comprising information means so that information concerning the fiber or an element such as a handpiece connected to the fiber may be transferred to the laser apparatus. Hereby, the laser apparatus may for example automatically adjust laser parameters on the basis of the information transferred from the information means.

According to the present invention, the above and other objects are fulfilled by a connector assembly for releasable connecting an optical fiber to a laser apparatus, the connector assembly comprising a first connector part being positioned at a first end of the optical fiber, and a second connector part being positioned at the laser apparatus, the first connector part and the second connector part being adapted to be releasable connected so that when the first connector part and the second connector part are connected, a laser beam emitted from the laser apparatus is coupled in to the first end of the optical fiber, and so that the first connector part protects a tip of the first end of the fiber when the first connector part and the second connector part are not connected, the first connector part further comprising a window, the window being positioned in the beam path of the laser beam emitted from the laser apparatus and at a distance from the fiber tip so that a laser beam incident on the window has a diameter on the window larger than the diameter of the laser beam focused on the fiber tip.

According to a second aspect of the invention, the above and other objects are fulfilled by a method of connecting an optical fiber to a laser apparatus, comprising: connecting a first connector part to a first end of the optical fiber, the fist connector part comprising a window, the window being positioned in the beam path of the laser beam emitted from the laser apparatus and at a distance from the fiber tip so that a laser beam incident on the window has a diameter on the window larger than the diameter of the laser beam focused on the fiber tip, connecting a second connector part to the laser apparatus, the first connector part and the second connector part being adapted to be releasable connected so that when the first connector part and the second connector part are connected, a laser beam emitted from the laser apparatus is coupled in to the first end of the optical fiber, and so that the first connector part protects a tip of the first end of the fiber when the first connector part and the second connector part are not connected.

Hereby, the fragile tip of the optical fiber may be protected against contamination. Without protecting the fiber tip, the fiber tip may be damaged either directly by having dust, dirt, etc. inducing scratches on the tip of the fiber. Hereby, the laser beam will be scattered and the coupling loss will be increased. Furthermore, dust or dirt present on the fiber tip may damage the fiber tip when the fiber is connected to the laser apparatus, since the dust and dirt present on the fiber tip may be burned off when exposed to the highly focused laser beam, and thus, damaging the fiber tip.

In order to further protect the fiber tip of the first end of the optical fiber, the first connector part comprises a window, so that the tip of the fiber is not directly exposed to the environments. The window is preferably positioned in the beam path of the laser beam emitted from the laser apparatus and at a distance from the fiber tip so that a laser beam incident on the window has a diameter on the window larger than the diameter of the laser beam focused on the fiber tip. Hereby, the power density of a laser beam incident at the window is at least substantially reduced compared to the optical power density of the highly focused laser beam on the fiber tip. The power density of the laser beam incident on the window may thus be reduced so that dust and dirt present on the window will not be burned off when exposed to the laser beam. Furthermore, the window may be manufactured of a material resistive to environmental influences, so that scratches, etc. are not easily induced in the window, and still further the window may preferably be manufactured of a material transparent to the laser beams emitted from a range of laser apparatuses. The window may for example be a window comprising sapphire which may have an antireflection coating, or it may be standard windows glass, such as BK7, or preferably such as quartz.

Furthermore, the window may be replaceable, thereby facilitating replacement of a damaged window without having to replace neither the fiber nor the first connector part. Hereby, the damaging of the window is not as serious as when the tip of the optical fiber is damaged, since a damaged window may be replaced by an undamaged window without having to replace the entire fiber. Furthermore, by having a replaceable window, the window may be checked for scratches, etc, for example at a regular basis. This is an advantage, since an undiscovered damaged window, or fiber tip, may cause for example increased coupling losses between the laser apparatus and the first end of the optical fiber. The intensity of the laser beam emitted from the second end of the optical fiber may thus be reduced relative to the expected intensity of the emitted laser beam, and when the expected intensity and the actual intensity of the emitted laser beam are not coincident, there will be a risk of for example over or under treatment of an area to be treated.

In a preferred embodiment the first connector part may be a male connector part, and the second connector part may be a corresponding female connector part. Thus, the tip of the fiber is preferably protected by a male connector part which may easily be inserted in a corresponding female connector part. Alternatively, the first connector part may be a female connector part and the second connector part may be a corresponding male connector part, or the first and second connector parts may be any other suitable kind of mating pairs of connector parts.

The connector assembly may further comprise a focusing lens, so that a collimated laser beam from the laser apparatus may be focused in the connector assembly, the focusing lens preferably being positioned so that the laser beam is focused on to the tip of the optical fiber.

The focusing lens may for example be positioned in the second connector part positioned on the laser apparatus. It is an advantage to have the focusing lens positioned in the second connector part since this reduces the task of alignment between the laser apparatus and the second connector part since then a collimated light beam and not a highly focused light beam is to be transferred from the laser apparatus to the second connector part.

Alternatively, the focusing lens may be positioned in the first connector part positioned on the optical fiber. Preferably, the focusing lens is positioned in the first connector part between the window and the fiber tip. Alternatively, the window may comprise the focusing lens, so that the focusing lens and the window are comprised in one element.

By having the focusing lens positioned in the first connector part, a further advantage is obtained, since a collimated light beam is then to be transferred not only from the laser apparatus to the second connector part, but also from the second connector part to the first connector part. This reduces the task of alignment between the second and first connector part since it, as mentioned above, is easier to connect a collimated light beam to the first connector part than to connect a highly focused laser beam to the first connector part. It is a further advantage of having the focusing lens positioned in the first connector part that the positioning of the focusing lens in relation to the tip of the optical fiber may be performed during manufacturing of the first connector part, thus reducing the demands for the overall tolerances of the dimensions on other parts of the connector assembly.

The connector assembly may be adapted to connect fibers of any thickness to the apparatus. Preferably, the fibers are provided with a standard fiber connector, such as an

SMA coupling, so that the fiber is in a well-defined position and so that the fiber and the standard connector may be to the connector according to the invention.

Preferably, the fiber may be permanently fastened to the connector assembly. The fiber may for example be glued, adhered, soldered, bonded, or by any other means fastened to the first connector part. Alternatively, the fiber may be exchangeable fastened to the connector assembly, and may for example be kept in the desired position by screws, bolts, knots, etc.

To ensure that the laser light is not emitted from the laser apparatus through the second connector part when the first and second connector parts are not mated, the connector assembly may comprise detection means for detecting whether the first connector part is connected to and correctly positioned in relation to the second connector part. The connector assembly may then further comprise the possibility of preventing the laser light from being emitted from the laser apparatus. The laser apparatus may thus for example comprise a shutter or a beam stop to prevent the laser beam from being emitted from the laser apparatus when the first and second connector parts are not connected or not connected correctly. Alternatively, the laser may be turned off if the first and second connector parts are not mated. It is an advantage that the laser beam will not be emitted from the laser apparatus without an optical fiber connected to the apparatus, especially when the laser beam is a high power laser beam. Furthermore, when the focusing lens is positioned in the laser apparatus or in the second connector part, the beam emitted from the second connector part is a highly focused laser beam and the risk of causing damage is thus high. It is thus an advantage of the connector assembly that a laser beam cannot be emitted from the laser apparatus or the second connector part if the first connector part is not connected to the second connector part or not correctly connected to the second connector part.

In the medical industry, lasers are commonly used for treatment of patients, such as for treatment of skin disorders, treatment of tumours, correction of the cornea, etc. Commonly, a handpiece for emission of the laser beam is attached to the laser apparatus via an optical fiber for facilitating convenient treatment of the area to be treated. The optical fiber may, thus, in a second end be connected to the handpiece and the handpiece may via the optical fiber be connected to various laser apparatuses depending on the specific used of the handpiece. The handpiece and the second end of the optical fiber may be permanently connected.

The handpiece may for example via the fiber be connected to a CO₂ laser for ablating dermal cells as water has a high energy absorbance at 10600 nm and as the CO₂ laser is capable of reliably delivering the required laser power. Another example is the connection of the handpiece via the fiber to a Nd YAG laser with a frequency doubled output beam in the 520-680 nm wavelength range for treatment of hypervasculation, and a still further example is to connect the handpiece via the fiber to a laser diode, such as an AlGaAs laser diode, for removal of excessive or unwanted hairs, etc. It is to be understood that many other lasers may be used in the medical industry and, also, that the connector assembly may be used in all kinds of industries using lasers and are not limited to medical treatment.

The connector assembly may further comprise information means for containing information about the fiber and/or a handpiece coupled to the fiber, and the laser apparatus may thus include information receiving means for reading and/or sensing the information contained in the information means of the connector assembly.

The information means may preferably be positioned at the first connector part and the second connector part may preferably comprise the information receiving means. The laser apparatus may be adapted to read the information receiving means positioned at the second connector part. Hereby, the information means and the information receiving means form part of the connector assembly. A standard port, such as a parallel port, a serial port, a USB port, an infrared port, or preferably a sub-D port, for transfer of electrical information signals may then connect the laser apparatus and the information receiving means. Alternatively, the information receiving means may be positioned on the laser apparatus and being adapted to read and/or sense the information contained in the information means.

The information transferred may comprise information about the diameter of the optical fiber, the spot size delivered by the optical fiber or fiber system at a treatment or working plane, the focal length of the fiber system, intended wavelength, the hours of operation for the optical fiber and/or a handpiece connected to the fiber, the transmission of the fiber so that the real effect may be shown on the laser, and/or information about a handpiece connected to the connector assembly, e.g. the type of handpiece connected, etc. The fiber system may comprise the fiber and one or more connectors terminating the fiber and may further comprise a fiber handpiece connected to the second end of the fiber, comprising collimating lenses, etc. for connecting the fiber to e.g. a treatment handpiece.

By measuring, for example, the transmission of the optical fiber at the second end of the optical fiber, a feedback may ensure that the actual value of the laser power emitted from the second end of the fiber may be shown on for example the laser apparatus. The transmission of the fiber may change, for example due to misalignment or due to micro cracks in the fiber, or the fiber may be a fragile fiber degrading by time and, hence, provided that the same optical power is emitted from the laser apparatus, the output from the second end of the optical fiber will be changed accordingly. Preferably, the laser apparatus will adjust the emitted power so that the optical power at the second end of the optical fiber corresponds to the optical power required for the actual use of the laser beam. Hereby, the user of the laser apparatus and fiber system will then not notice that the transmission of the optical fiber has been changed.

By transferring information about the diameter of the fiber to the laser apparatus, it may be ensured that too much power is not transmitted through a specific fiber, thus reducing the risk of burning off the fiber. Furthermore, information about the type of fiber being connected to the laser apparatus may ensure that a laser beam is not emitted from the laser apparatus if, for example, a standard fiber not suitable for transmission of a CO₂ laser beam is connected to a CO₂ laser apparatus.

Furthermore, information about a handpiece connected to the second end of the optical fiber, for example the type or serial number of the handpiece, may be useful when selecting various laser settings.

The information contained in the information means may be in the form of an information code. The information code may be transferred between the information means and the information receiving means by any means, such as by electrical, optical, mechanical and/or magnetical means.

Static information, i.e. information that not need a regular update, such as the type of handpiece connected to the fiber, intended wavelength, spot size, etc, may be transferred via mechanical means, so that the information may be transferred via sequential mechanical activation of two or more individual contacts positioned in the first and/or second connector part.

The information code may be transferred to the connector assembly via an optical fiber. The information may for example be an optical signal which may be overlaid the laser beam signal and transferred in the same optical fiber as the laser beam. Alternatively, the laser beam may be transferred in a high power light transmission channel and the information code may then be transferred in a low power information transmission channel. Both transmission channels may be present in the same fiber optic cable.

Furthermore, the information code may be transferred via electrical means, such as an electrical line carrying an electrical information signal.

The connector assembly may further comprise a display for displaying the information contained in the information means or any processed information derivable from the information. In a preferred embodiment the information or the processed information is displayed on a display present on the laser apparatus.

### BRIEF DESCRIPTION OF THE DRAWING

FIG. 1 shows a connector assembly wherein a focusing lens is positioned in the second (female) connector part,

FIG. 2 shows a schematic drawing of a connector assembly according to FIG. 1, wherein it is seen that the fiber tip is directly exposed to the surroundings,

FIG. 3 shows a connector assembly having a focusing lens positioned in the first (male) connector part and having contact sensors mounted on the second (female) connector part,

FIG. 4 shows a schematic drawing of a connector assembly according to FIG. 2, wherein the focusing lens is positioned in the first (male) connector part focusing the light beam onto the tip of the fiber,

FIG. 5 shows a safety principle wherein two contact sensors are activated only if the first (male) and second (female) connector part are correctly mated, and

FIG. 6a-d show different methods of transferring information.

### DETAILED DESCRIPTION OF THE DRAWING

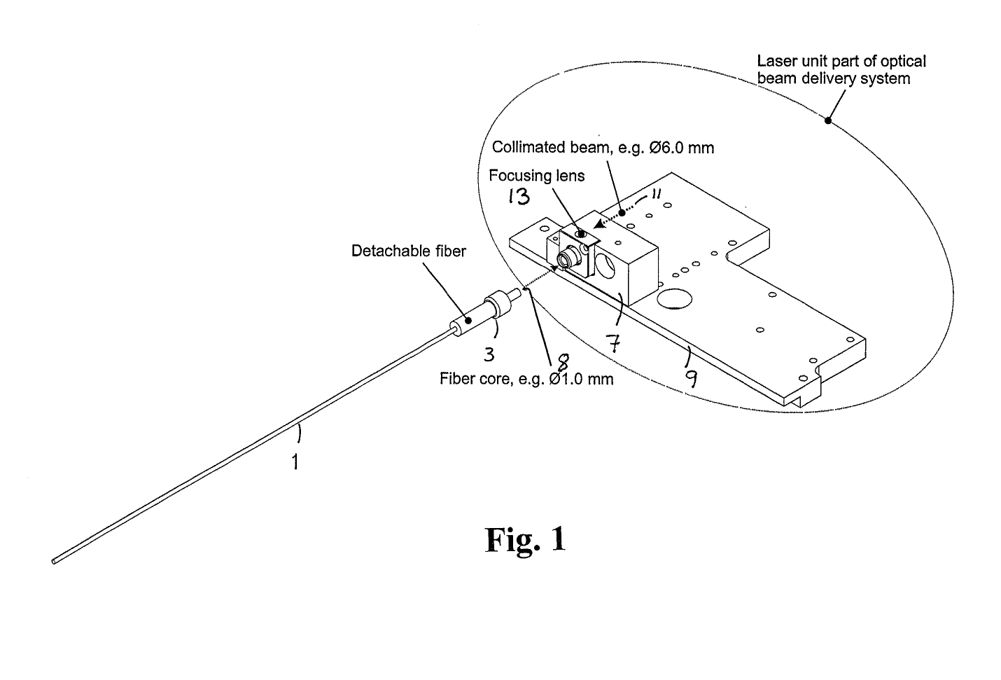

In FIG. 1, a connector assembly for connecting an optical fiber 1 to a laser apparatus is shown. The optical fiber 1 is permanently fastened to the first connector part 3, being a male connector part. In the embodiment shown, the fiber core of the optical fiber has a diameter of 1,0 mm. The male connector part 3 is connected to the second connector part 7, being a female connector part. The female connector part 7 is positioned on a platform 9 connecting the fiber to a laser apparatus (not shown). The laser apparatus deliver a collimated laser light beam 11 with a diameter of 6,0 mm to the female connector part 7. The female connector part 7 comprises a focusing lens 13 for focusing the collimated laser light beam on to the tip of the fiber, when the male and female connector parts are mated.

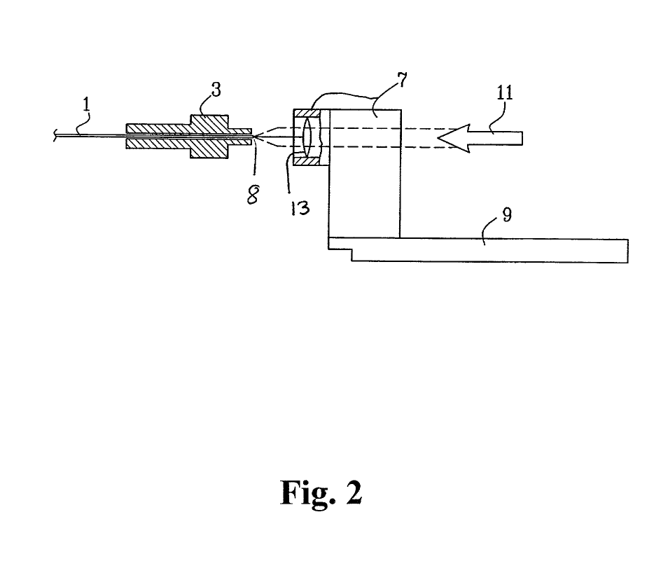

FIG. 2 shows a schematic drawing of the fiber connector of FIG. 1. It is seen that the fiber 1, where only the core part of the fiber is shown for simplicity, is attached to the male connector part 3. It is further seen that the fiber tip 8 is directly exposed to the surroundings without any protection. The female connector part 7 comprises the focusing lens 13 and the laser light beam 11 is focused on to the tip of the fiber 8 when the male and female connector parts are mated.

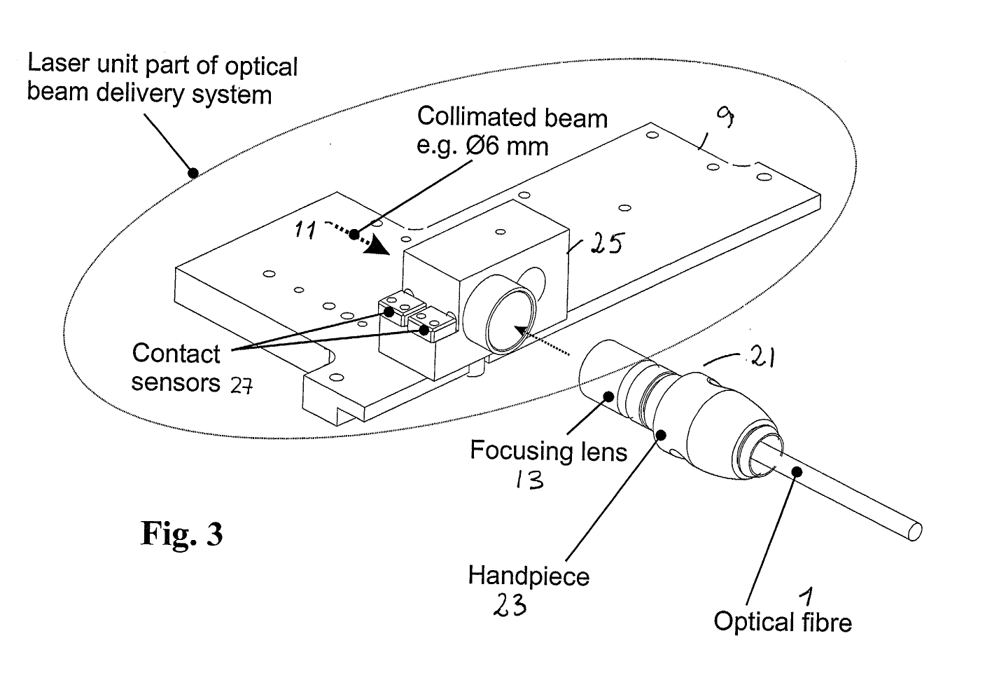

In FIG. 3, another embodiment of the present invention is shown. An optical fiber 1 is permanently fastened to the first connector part 21, being a male connector part. The male connector part 21 comprises the focusing lens 13 for focusing the collimated light beam 11 on to the fiber tip 8. The male connector part 21 further comprises a handpiece 23 for easy mating and unmating of the male and female connector parts 21, 25. The female connector part 25 is positioned on a platform 9 for mounting on a laser apparatus (not shown) emitting a collimated laser light beam 11. The female connector part 25 further comprises two contact sensors 27 adapted to detect when a male connector part 21 is correctly positioned in the female connector part 25.

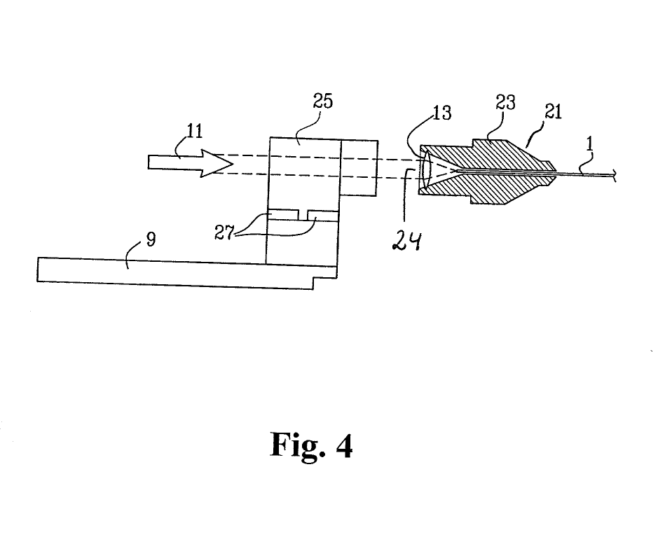

In FIG. 4, a schematic drawing of the fiber connector of FIG. 3 is shown. The male connector part 21 comprises the focusing lens 13, the focusing lens being positioned in an opening 24 of the male connector part 21 so that the tip of the fiber 8 is protected against dust, dirt and other influences from the environment. Only the core of the fiber 1 is shown for simplicity. The opening is here shown to have a cone shape, but it is envisaged that the opening may have any applicable form, such as rectangular, quadratic, triangular, etc.

A further advantage of having the focusing lens positioned in the male connector part 21 is that the tolerances in the manufacturing of the connector assembly is significantly reduced in that, in this preferred embodiment of the invention, a collimated light beam is transmitted from the female connector part 25 to the male connector part 21, where the light beam is focused on to the tip of the fiber 8. The tolerances when connecting a relatively wide collimated light beam from the male connector part 21 to the female connector part 23 are not as restrictive as when connecting a highly focused light beam from one connector part to another.

It is, though, envisaged that the focusing lens may be positioned in the female connector part with a window, such as a standard window glass, such as BK7 or, preferably, such as quartz, replacing the focusing lens. The tip of the fiber 8 is hereby protected against any environmental influences, thus increasing the lifetime of the fiber and fiber tip as no scratches are induced on the fiber tip and, further but not less importantly, ensure that no dust or dirt are present on the fiber tip 8 when the highly focused light beam fall on the fiber tip. Dust or dirt present on the fiber tip may be burned off when the highly focused light beam is incident on the fiber tip and thus damage the fragile fiber tip.

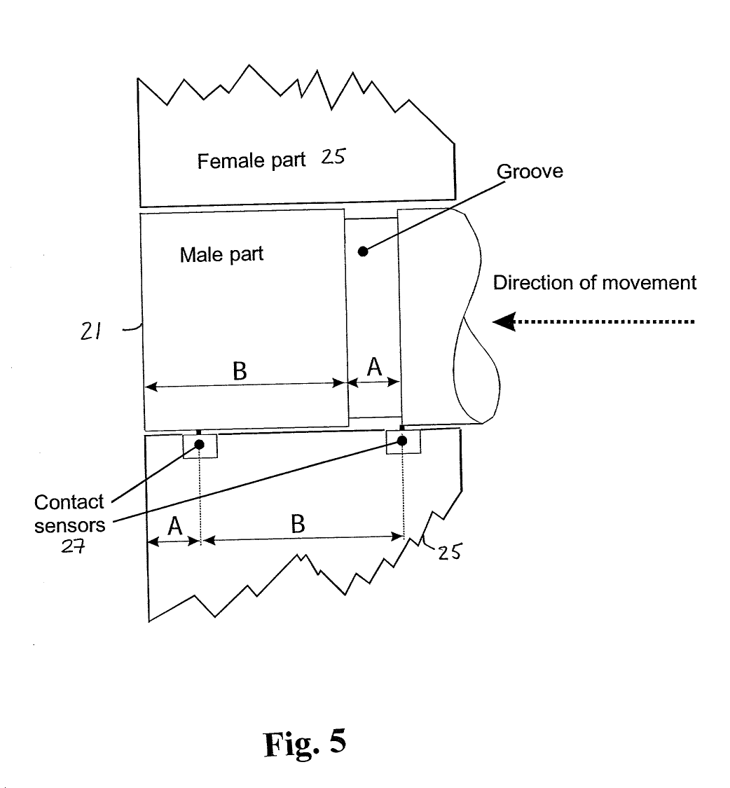

The principle of the contact sensors is shown in more detail in FIG. 5, where the contact sensors or the detection means 27 are positioned at the female connector part 25. The contact sensors 27 are positioned with a distance A and A+B from an end stop (not shown). The male connector part 21 comprises a groove part 31 having a length A and being positioned at a distance B from the end stop (not shown), so that both contact sensors 27 are activated only when the male connector part 21 is positioned correctly in the female connector part 25. It is envisaged that any number of contact sensors suitable for the detection of the correctly positioned connector parts may be used. The contact sensors 27 may be connected to the laser apparatus (not shown), so that a laser light beam 11 is only emitted when the connector parts 21, 25 are mated correctly. The contact sensors 27 detect whether the male and female parts are mated and thus detect whether a laser light beam is allowed to be transmitted through the connector assembly.

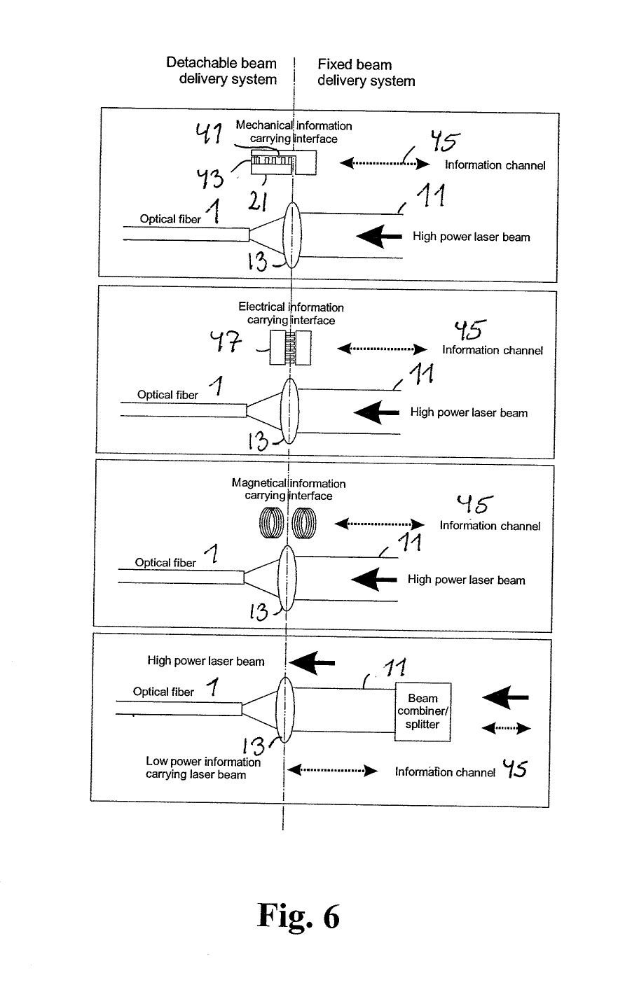

Different methods of transferring information and different interface means are shown in FIG. 6a-d. To the left in the figures, the detachable beam delivery system, i.e. the fiber and the first connector part, is shown and to the right is shown the high power light beam 11 emitted from the laser apparatus (not shown). In FIG. 6a, a mechanical information carrying interface is shown. In the second connector part two or more contacts 41 are positioned, and the contacts 41 are activated by corresponding grooves or indentations 43 in the first connector part. The contacts 41 are preferably axially displaced so that the connection of the first connector part to the second connector part alternately activates each of the contacts so that the contacts go on and off in a predefined bit-sequence. The bit sequence thus being the information code transferred to the second connector part and subsequently to the laser apparatus via information channel 45.

In FIG. 6b, an example of an electrical information carrying interface is shown. An electrical plug 47 is inserted into an plug receiver for transfer of an electrical information code and subsequent transfer to the laser apparatus. The electrical information carrying interface is in FIG. 6c replaced by a magnetical information carrying interface for transfer of a magnetic information code.

In FIG. 6d, a low power laser beam transfers an optical information code to the laser apparatus from the handpiece. The high power laser beam and the low power information laser beam may be transferred in the same fiber as overlaid signals, or they may be transferred in two different optical fibers, preferably comprised in the same cable. The second connector part or the laser apparatus may thus comprise a beam splitter/ beam combiner for, respectively, combining and splitting the two beams.

1. A connector assembly for releasable connecting an optical fiber to a laser apparatus, the connector assembly comprising a first connector part being positioned at a first end of the optical fiber, and a second connector part being positioned at the laser apparatus, the first connector part and the second connector part being adapted to be releasable connected so that when the first connector part and the second connector part are connected, a laser beam emitted from the laser apparatus is coupled in to the first end of the optical fiber, and so that the first connector part protects a tip of the first end of the fiber when the first connector part and the second connector part are not connected, the first connector part further comprising a window, the window being positioned in the beam path of the laser beam emitted from the laser apparatus and at a distance from the fiber tip so that a laser beam incident on the window has a diameter on the window larger than the diameter of the laser beam focused on the fiber tip.

2. A connector assembly according to claim 1, wherein the first connector part is a male connector part, and the second connector part is a corresponding female connector part.

3. A connector assembly according to claim 1, wherein the window is made of an optical transparent material.

4. A connector assembly according to claim 1, wherein the second connector part comprises a focusing lens for focusing the laser beam.

5. A connector assembly according to claim 1, wherein the first connector part further comprises a focusing lens, so that the connector assembly is adapted to couple a collimated light beam from the laser apparatus in to the fiber, the focusing lens being adapted to focus the collimated light beam on the fiber tip.

6. A connector assembly according to claim 5, wherein the focusing lens is positioned between the window and the fiber tip.

7. A connector assembly according to claim 1, wherein the window has at least one plane surface.

8. A connector assembly according to claim 5, wherein the window comprises the focusing lens.

9. A connector assembly according to claim 1, wherein the connector assembly is adapted to connect fibers of any thickness to the apparatus.

10. A connector assembly according to claim 1, wherein the window is replaceable.

11. A connector assembly according to claim 1, wherein the fiber is permanently fastened to the connector assembly.

12. A connector assembly according to claim 1, further comprising detection means for detecting if a first connector part is inserted in and correctly positioned in the second connector part so that a laser beam cannot be transmitted through the connector assembly if the first and second connector parts are not positioned correctly.

13. A connector assembly according to claim 1, wherein a second end of the optical fiber is connected to a handpiece for emission of the laser beam.

14. A connector assembly according to claim 1, further comprising information means for containing information about the fiber and/or a light emitting device, such as a handpiece coupled to the fiber, a laser apparatus including information receiving means for reading and/or sensing the information contained in the information means of the connector assembly.

15. A connector assembly according to claim 1, wherein the first connector part further comprises information means for containing information about the fiber and/or a handpiece coupled to the fiber, the second connector part comprising information receiving means for reading and/or sensing the information contained in the information means.

16. A connector assembly according to claim 14, wherein the information contained in the information means is in the form of an information code.

17. A connector assembly according to claim 14, wherein information is transferred from the handpiece to the information means via electrical, optical, mechanical and/or magnetical means.

18. A connector assembly according to claim 17, wherein the information is transferred to the connector assembly via an optical fiber.

19. A connector assembly according to claim 17, wherein the laser beam is transferred in a high power light transmission channel and the information is transferred in a low power information transmission channel.

20. A connector assembly according to claim 17, wherein the information is transferred via sequential mechanical activation of two or more individual contacts positioned in the first/second connector part.

21. A connector assembly according to claim 14, wherein the information comprises information about the diameter of the optical fiber, the spot size delivered by the optical fiber (or fiber system) at a treatment or working plane, the focal length of the fiber system, intended wavelength, the hours of operation for the optical fiber and/or a handpiece connected to the fiber, the transmission of the fiber so that the real effect may be shown on the laser, and/or information about a handpiece connected to the connector assembly, such as the type of handpiece connected.

22. A method of connecting an optical fiber to a laser apparatus, comprising:
connecting a first connector part to a first end of the optical fiber, the fist connector part comprising a window, the window being positioned in the beam path of the laser beam emitted from the laser apparatus and at a distance from the fiber tip so that a laser beam incident on the window has a diameter on the window larger than the diameter of the laser beam focused on the fiber tip,
connecting a second connector part to the laser apparatus, the first connector part and the second connector part being adapted to be releasable connected so that when the first connector part and the second connector part are connected, a laser beam emitted from the laser apparatus is coupled in to the first end of the optical fiber, and so that the first connector part protects a tip of the first end of the fiber when the first connector part and the second connector part are not connected.

23. A method according to claim 22, further comprising transferring an information code from a light emitting device, such as a handpiece, connected to a second end of the optical fiber, to the laser apparatus.
